(19) United States
(12) Patent Application Publication
(10) Pub. No.: US 2025/0253457 A1
(43) Pub. Date: Aug. 7, 2025

(54) BIPOLAR BATTERY

(71) Applicant: TOYOTA JIDOSHA KABUSHIKI KAISHA, Toyota-shi (JP)

(72) Inventor: Masato KAMIYA, Toyota-shi (JP)

(73) Assignee: TOYOTA JIDOSHA KABUSHIKI KAISHA, Toyota-shi (JP)

(21) Appl. No.: 19/010,436

(22) Filed: Jan. 6, 2025

(30) Foreign Application Priority Data
Feb. 1, 2024 (JP) 2024-014421

(51) Int. Cl. H01M 50/198; H01M 4/02; H01M 50/489

(52) U.S. Cl. CPC H01M 50/198; H01M 4/02; H01M 50/489; H01M 2004/029; H01M 2200/10

(57) ABSTRACT

In a bipolar battery, a bipolar electrode is laminated and sealed in a sealing portion, and a separator having a predetermined shutdown voltage is interposed between a positive electrode layer and a negative electrode layer in the bipolar electrode. In the sealing portion, a heterogeneous portion is formed on the long side wall, and the heterogeneous portion has a melting point lower than the melting point of the other portion of the sealing portion and is equal to or higher than the shutdown voltage of the separator. Thus, in the bipolar battery, since the temperature in the sealing portion increases and the heterogeneous portion is more likely to be damaged than the other portions by reaching the melting point of the heterogeneous portion, the portion that may be damaged due to the temperature increase becomes clear, it is easy to secure the safety against damage.

### CROSS-REFERENCE TO RELATED APPLICATION

This application claims priority to Japanese Patent Application No. 2024-014421 filed on Feb. 1, 2024, incorporated herein by reference in its entirety.

### BACKGROUND

### 1. Technical Field

The present disclosure relates to a bipolar battery.

### 2. Description of Related Art

Japanese Unexamined Patent Application Publication No. 2019-091606 (JP 2019-091606 A) discloses a bipolar battery. In the bipolar battery, a plurality of bipolar electrodes each having a positive electrode formed on one surface and a negative electrode formed on the other surface is stacked via a separator to form an electrode stack portion. Further, in the bipolar battery, a seal frame is disposed so as to surround the electrode stack portion, and the seal frame has a plurality of primary seal portions formed in a frame shape to hold the bipolar electrode, and a secondary seal portion disposed around the primary seal portions.

Further, in the bipolar battery, the internal space between the bipolar electrodes defined by the secondary seal portion is liquid-tightly filled with an electrolytic solution. The internal space is sealed by the primary seal portions, and the internal space is further sealed by the secondary seal portion surrounding the primary seal portions.

### SUMMARY

In a secondary battery such as a bipolar battery, a temperature rise may occur, or a gas or the like may be generated as the temperature rises. In the bipolar battery, if a temperature rise occurs and a gas is generated, the internal pressure rises due to the generated gas, and the spacing between the current collectors changes or the current collectors are deformed.

Further, in the bipolar battery, when the internal pressure rises and exceeds the withstanding pressure of the frame body, damage occurs. This damaged portion is often affected by variations in the withstanding pressure during manufacture, and it is difficult to predict the portion to be damaged, and therefore it is difficult to predict the effect of the damage.

An object of the present disclosure is to provide a bipolar battery that is easy to ensure safety when damage due to a temperature rise occurs when an internal pressure rises.

In order to achieve the above object, a first aspect provides a bipolar battery including: a bipolar electrode in which a positive electrode layer and a negative electrode layer are disposed between a pair of current collectors, and a separator as an electrolyte layer having a predetermined shutdown temperature is disposed between the positive electrode layer and the negative electrode layer;
a sealing portion in which each bipolar electrode is sealed by holding a peripheral edge portion of each of the current collectors when the bipolar electrode is stacked and accommodated inside the sealing portion; and
a heterogeneous portion provided in the sealing portion along a stacking direction of the bipolar electrode, the heterogeneous portion having a melting point that is lower than a melting point of other portions of the sealing portion and equal to or higher than the shutdown temperature of the separator.

In the bipolar battery according to the first aspect, a plurality of bipolar electrodes is stacked. In each of the bipolar electrodes, a positive electrode layer and a negative electrode layer are disposed between a pair of current collectors, and a separator as an electrolyte layer having a predetermined shutdown temperature is disposed between the positive electrode layer and the negative electrode layer. In a sealing portion, each of the bipolar electrodes is sealed by holding a peripheral edge portion of each of the current collectors when the bipolar electrodes are stacked and accommodated inside the sealing portion.

In the sealing portion, a heterogeneous portion is provided along a stacking direction of the bipolar battery, and the heterogeneous portion has a melting point that is lower than a melting point of other portions of the sealing portion and equal to or higher than the shutdown temperature of the separator.

Thus, the heterogeneous portion functions as a thermally fragile portion in the sealing portion, and the heterogeneous portion starts melting earlier than the other portions of the sealing portion when the temperature in the sealing portion rises. Thus, it is possible to appropriately control the portion to be damaged when the internal pressure rises, by reducing the pressure from the heterogeneous portion even if the internal pressure in the sealing portion rises. In addition, it is easy to secure safety, since it is possible to grasp a portion to be damaged when the temperature rises.

A second aspect provides the bipolar battery according to the first aspect, in which:
the sealing portion includes a plurality of frame bodies, the frame bodies being stacked with the bipolar electrode accommodated inside each of the frame bodies to allow the bipolar electrode to be stacked, and the frame bodies holding the peripheral edge portion of each of the current collectors of the bipolar electrode; and
the heterogeneous portion is provided on each of the frame bodies and provided in the stacking direction in the sealing portion.

In the bipolar battery according to the second aspect, the sealing portion is formed by stacking a plurality of frame bodies. When the bipolar electrode is accommodated and stacked in each of the frame bodies, the peripheral edge portion of each of the pair of current collectors of each bipolar electrode is held and sealed in the frame body.

In addition, each of the frame bodies is provided with a heterogeneous portion, and a heterogeneous portion is formed in the stacking direction in the sealing portion by stacking the frame bodies. Thus, a heterogeneous portion corresponding to the bipolar electrode can be easily formed in the sealing portion.

A third aspect provides the bipolar battery according to the first or second aspect, in which:
the sealing portion is formed in a rectangular shape by a short side wall and a long side wall that is longer than the short side wall when seen in the stacking direction of the bipolar electrode; and
the heterogeneous portion is provided at an intermediate portion along a direction intersecting the stacking direction of the long side wall.

In the bipolar battery according to the third aspect, the heterogeneous portion is provided on the long side wall that is longer than the short side wall when seen in the stacking direction of the bipolar electrode. The long side wall, where heat shrinkage is more likely to occur than the short side wall, can be effectively damaged when the temperature in the sealing portion rises, and it is easier to secure safety.

A fourth aspect provides the bipolar battery according to any one of the first to third aspects, in which the heterogeneous portion has the melting point that is higher than the shutdown temperature of the separator.

In the bipolar battery according to the fourth aspect, the melting point of the heterogeneous portion is higher than the shutdown temperature of the separator. Therefore, the sealing portion is damaged at the heterogeneous portion when the shutdown function of the separator does not work in spite of a temperature rise. Accordingly, it is possible to suppress the sealing portion being unnecessarily damaged.

According to the present disclosure, the sealing portion can be damaged at a predetermined heterogeneous portion, even if the temperature in the sealing portion rises and the internal pressure rises, and thus it is easy to secure safety even when damage occurs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a main portion of a bipolar battery according to an embodiment of the present disclosure as viewed from the side;

FIG. 2 is a top plan view schematically showing a bipolar battery;

FIG. 3A is a schematic diagram illustrating measurement of the shutdown temperature of a separator;

FIG. 3B is a diagram showing a schematic of the change in resistivity with respect to temperature;

FIG. 4 is a diagram according to a first embodiment; and

FIG. 5 is a diagram according to a second embodiment.

### DETAILED DESCRIPTION OF EMBODIMENTS

Hereinafter, a bipolar battery according to the present embodiment will be described in detail with reference to the drawings.

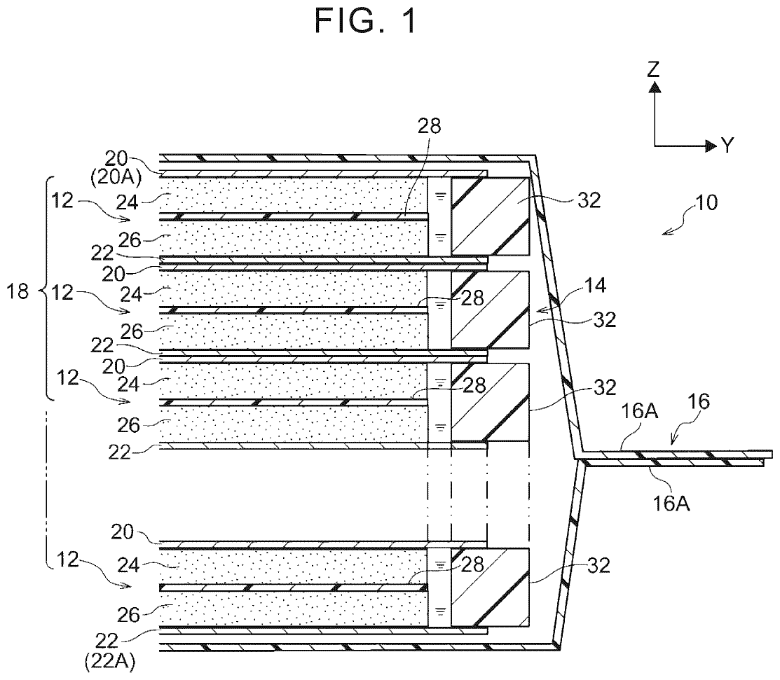

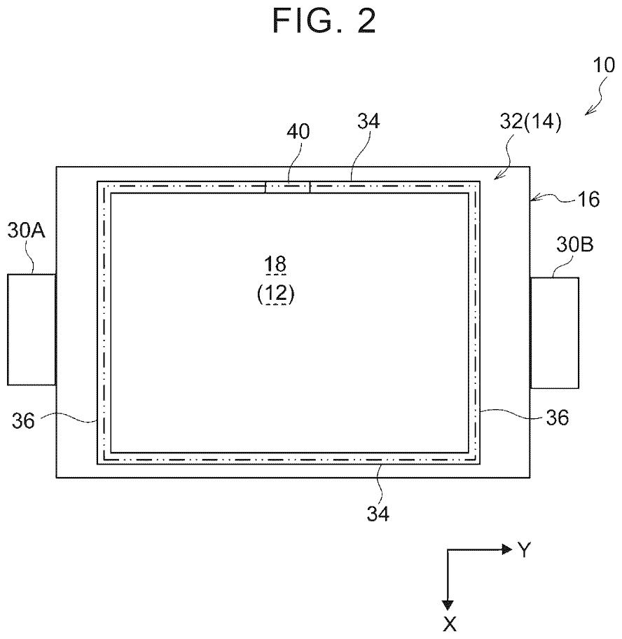

FIG. 1 schematically shows a cross-sectional view of a main part of a bipolar battery 10 according to the present embodiment in a side view, and FIG. 2 schematically shows a plan view of a main part of the bipolar battery 10 in a top view. Note that, in the drawings, directions crossing (orthogonal) to each other are indicated as arrows X, Y, and Z, respectively, and one side in the width direction, one side in the longitudinal direction, and an upper side in the vertical direction of the bipolar battery 10 in the following description correspond to arrows X, Y, and Z, respectively. In the following description, the vertical direction is also referred to as a stacking direction.

The bipolar battery 10 according to the present embodiment is a lithium ion battery in which a metal oxide containing lithium ions is used as an electrolytic solution, and the bipolar battery 10 functions as a storage battery (secondary battery). In addition, a plurality of bipolar batteries 10 is electrically connected in series (or connected in parallel) to form a power storage device having a predetermined voltage. Note that the bipolar battery 10 is not limited to a lithium-ion battery, and various batteries such as a nickel-metal hydride secondary battery can be used.

As illustrated in FIG. 1, the bipolar battery 10 includes a plurality of bipolar electrodes 12 as electrode bodies, a sealing portion 14, and a laminate portion 16. The bipolar battery 10 is of a bipolar type. In the bipolar battery 10, the electrode stack 18 in which the plurality of bipolar electrodes 12 are stacked in the vertical direction to form the electrode stack 18 is sealed in the sealing portion 14. The sealing portion 14 is integrally housed in the laminate portion 16 and sealed.

The bipolar electrode 12 includes current collectors 20 and 22 forming positive and negative electrodes, a positive electrode layer 24, a negative electrode layer 26, and a separator 28 serving as an electrolyte layer. Conductive metallic materials such as Al, SUS, Ni, Cu are used for the current collectors 20 and 22. In the bipolar electrode 12, a positive electrode layer 24 having a required thickness is formed by coating a known positive electrode active material on one surface of the current collector 20, and a negative electrode layer 26 having a required thickness is formed by coating a known negative electrode active material on one surface of the current collector 22.

In the bipolar electrode 12, the positive electrode layer 24 and the negative electrode layer 26 face each other, and the separator 28 is disposed between the positive electrode layer 24 and the negative electrode layer 26, and in the bipolar electrode 12, the separator 28 is interposed between the positive electrode layer 24 and the negative electrode layer 26. Thus, the bipolar electrode 12 is formed by sequentially stacking the current collector 20, the positive electrode layer 24, the separator 28, the negative electrode layer 26, and the current collector 22.

In the electrode stack 18, when a plurality of bipolar electrodes 12 are stacked, a current collector 20 of one bipolar electrode 12 and a current collector 22 of the other bipolar electrode 12 face each other between adjacent bipolar electrodes 12. Thus, in the electrode stack 18, a plurality of bipolar electrodes 12 are connected in series.

In the bipolar battery 10, the current collector 20 in which the positive electrode layer 24 at the final end along the stacking direction is disposed is the positive electrode final electrode 20A, and the current collector 22 in which the negative electrode layer 26 at the final end along the stacking direction is disposed is the negative electrode final electrode 22A (see FIG. 1). In the bipolar battery 10, the positive electrode tab 30A is connected to the positive electrode final electrode 20A and the negative electrode final electrode 22A is connected to the negative electrode tab 30B, and in the bipolar battery 10, a predetermined voltage is generated between the positive electrode tab 30A and the negative electrode tab 30B.

The current collectors 20 and 22 have a substantially rectangular shape in which the longitudinal direction is along the arrow Y direction and the width direction is along the arrow X direction in the stacking direction (plan view). In the bipolar electrode 12, a positive electrode layer 24 having a substantially rectangular shape in plan view is applied to a central portion of the current collector 20, and a negative electrode layer 26 having a substantially rectangular shape in plan view is applied to a central portion of the current collector 22. Further, in the current collectors 20 and 22, the outer sides of the positive electrode layer 24 and the negative electrode layer 26 are uncoated portions, respectively, and the current collectors 20 and 22 are provided with uncoated portions at respective peripheral portions.

The separator 28 has a substantially rectangular shape similar to that of each of the current collectors 20 and 22, and the separator 28 has a vertical dimension (a longitudinal dimension) and a width dimension (a width dimension) smaller than that of each of the current collectors 20 and 22. The separator 28 has a vertical dimension (longitudinal dimension) and a width dimension that are slightly larger than the positive electrode layer 24 and the negative electrode layer 26, respectively.

As a result, in the bipolar electrode 12, the uncoated portions of the current collectors 20 and 22 protrude over the entire circumference outside the positive electrode layer 24, the negative electrode layer 26, and the separator 28 in the stacking direction.

As the separator 28, a solid electrolyte layer containing a known solid electrolyte is used. The separator 28 forms an electrolyte layer having electrical insulation and oxidation resistance and reduction resistance between the positive electrode layer 24 and the negative electrode layer 26. This allows the separator 28 to pass (transmit) charge carriers such as lithium ions while preventing an electrical short circuit between the positive electrode layer 24 and the negative electrode layer 26.

Further, the separator 28 is provided with a shutdown function of stopping the ion-permeable function by reaching a preset temperature (shutdown temperature Tsd). Thus, in the bipolar battery 10, even when unexpected heat generation occurs, the separator 28 reaches the shutdown temperature Tsd, so that charging and discharging are stopped and the temperature rise can be suppressed.

The sealing portion 14 is formed in a substantially box shape as a whole by stacking a plurality of frame bodies 32 each formed in a rectangular frame shape. The frame body 32 is made of, for example, resin, and the frame body 32 includes a long side wall 34 whose longitudinal direction is along the arrow Y direction, and a short side wall 36 whose longitudinal direction is shorter than the long side wall 34 and which is along the arrow X direction. The frame body 32 is formed in a rectangular frame shape in which the long side walls 34 and the short side walls 36, each of which is arranged in a pair, are integrated. The frame body 32 has a height dimension (lamination direction dimension) similar to the spacing dimension between the lower surface of the current collector 20 and the upper surface of the current collector 22 in the bipolar electrode 12.

Further, the frame body 32, the dimension along the length direction of the inner surface (spacing dimension of the inner surface of the short side wall 36), and the dimension along the width direction (spacing dimension of the inner surface of the long side wall 34) is smaller than the dimension along the same direction of the current collectors 20 and 22, respectively. In addition, in the frame body 32, a dimension along the length direction of the outer shape (a length dimension of the long side wall 34) and a dimension along the width direction (a length dimension of the short side wall 36) are larger than a dimension along the same direction of the current collectors 20 and 24, respectively.

Thus, in the bipolar electrode 12, the uncoated portion of the lower surface peripheral edge of the current collector 20 is disposed on the upper surface of the frame body 32. The uncoated portion of the upper peripheral edge of the current collector 22 is disposed on the lower surface of the frame body 32, and the positive electrode layer 24, the separator 28, and the negative electrode layer 26 are accommodated in the frame body 32.

In the bipolar battery 10, the bipolar electrodes 12 are stacked by stacking the frame bodies 32 each containing the bipolar electrodes 12. In addition, in the bipolar battery 10, the stacked frame body 32 is held in a state of being in pressure-tight contact, so that the bipolar electrode 12 is accommodated and sealed in the frame body 32, and the electrode stack 18 is sealed and held in the sealing portion 14.

In the bipolar battery 10, an electrolytic solution is sealed in the sealing portion 14. The electrolytic solution is enclosed in an internal space between the current collectors 20 and 22 in the frame body 32.

For example, a plurality of (e.g., two) laminate sheet 16A are used as the laminate portion 16, and the sealing portion 14 is sealed by melt-bonding the overlapping portions of the laminate sheet 16A disposed so as to surround the sealing portion 14.

On the other hand, as shown in FIG. 2, each of the frame bodies 32 is provided with a heterogeneous portion 40, and the heterogeneous portion 40 is formed to have a required length in one of the longitudinal intermediate portions of the pair of long side walls 34. Therefore, the sealing portion 14, the heterogeneous portion 40 on the surface of one of the long side wall 34 side is formed so as to be continuous in the vertical direction.

The heterogeneous portion 40 is a thermally fragile portion in the frame body 32, and the heterogeneous portion 40 is made of a material whose melting point (melting temperature) Tm is lower than the melting point Tms of the other portion of the frame body 32 (Tm<Tms). The heterogeneous portion 40 may be made of, for example, a material similar to the other portions by the frame body 32, or a material that differs from the other portions may be used, but is made of a material whose melting point Tm is lower than the melting point Tms of the other portions. In addition, the temperature of the heterogeneous portion 40 is set such that the melting point Tm is higher than the shutdown temperature Tsd of the separators 28 (Tsd<Tm<Tms).

As a result, in the frame body 32, the heterogeneous portion 40 melts before the other portions due to the increase in temperature, and the inner side of the long side wall 34 can be released toward the outside.

In the bipolar battery 10 configured as described above, the uncoated portions of the current collector 20 coated with the positive electrode layer 24 and the current collector 22 coated with the negative electrode layer 26 are sandwiched between the frame bodies 32 which are vertically adjacent to each other. The bipolar electrode 12 is accommodated in the frame body 32 and held by the sealing portion 14. Thus, in the bipolar battery 10, the bipolar electrode 12 is housed in the frame body 32 and enclosed in the sealing portion 14.

In the bipolar battery 10, the positive electrode final electrode 20A and the positive electrode tab 30A are connected, and the negative electrode final electrode 22A and the negative electrode tab 30B are connected. Thus, in the bipolar battery 10, DC power applied between the positive electrode tab 30A and the negative electrode tab 30B is charged, and DC power of a predetermined voltage can be outputted from between the positive electrode tab 30A and the negative electrode tab 30B.

Incidentally, in the bipolar battery 10, a temperature rise may occur in the bipolar electrode 12 or the like due to various factors such as deterioration due to a use state (charge/discharge state) or deterioration with time. In addition, in the bipolar battery 10, gas may be generated with an increase in temperature, and in the bipolar battery 10, the internal pressure increases due to an increase in temperature or generation of gas, and there is a high possibility that the sealing portion 14 in which the bipolar electrode 12 is enclosed is damaged.

Here, each of the frame bodies 32 forming the sealing portion 14, the heterogeneous portion 40 of the melting point Tm lower than the melting point Tms of the other portions in the preset portion is formed. The heterogeneous portion 40 is formed continuously in the vertical direction in the sealing portion 14.

Therefore, in the frame body 32, when the temperature T in the bipolar electrode 12 or the like exceeds the melting point Tm of the heterogeneous portion 40 (T≥Tm), the heterogeneous portion 40 changes from the solid phase to the liquid phase. As a result, in the bipolar battery 10, damage is likely to occur in the heterogeneous portion 40 in the sealing portion 14 (the frame body 32) due to an increase in the temperature T. When the internal pressure is increased in the sealing portion 14, the inside of the sealing portion 14 is decompressed due to breakage that opens the inside outward in the heterogeneous portion 40.

As described above, in the bipolar battery 10, as the temperature T in the sealing portion 14 in which the bipolar electrode 12 is encapsulated increases, the heterogeneous portion 40, which is a predetermined portion, is likely to be damaged. Therefore, in the bipolar battery 10, when the internal pressure in the sealing portion 14 increases, the heterogeneous portion 40 is damaged. Thus, in the bipolar battery 10, by providing the heterogeneous portion 40 in the sealing portion 14 (the frame body 32), it is possible to control the damaged portion of the sealing portion 14 when the temperature Tin the sealing portion 14 is increased and the internal pressure is increased, it is easy to secure the safety when the damage occurs in the sealing portion 14.

Further, in the bipolar battery 10, the shutdown temperature Tsd is set in the separator 28 of the bipolar electrode 12. In the bipolar battery 10, the melting point Tm of the heterogeneous portion 40 is set higher than the shutdown temperature Tsd (Tm>Tsd).

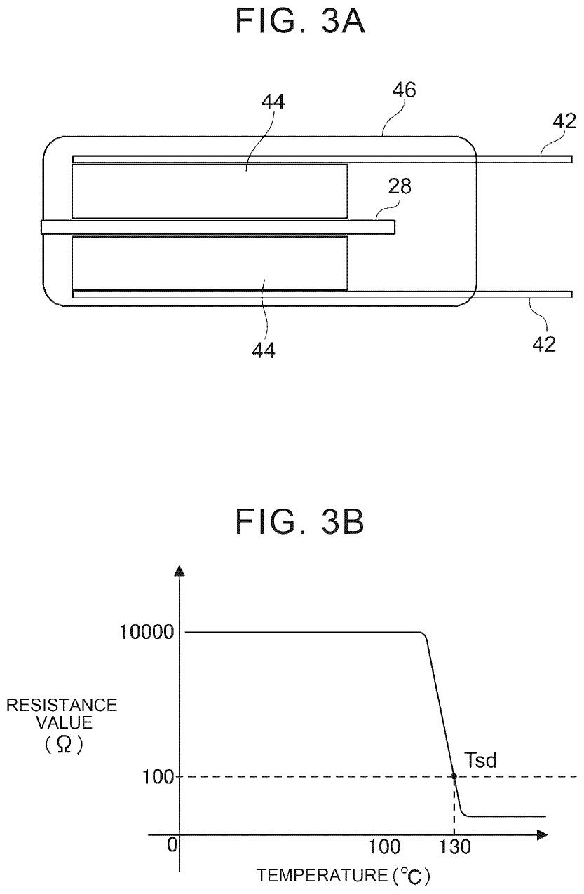

Here, the shutdown temperature Tsd of the separators 28 will be described. In FIG. 3A, a schematic configuration diagram of measurement of the shutdown temperature Tsd is shown, and in FIG. 3B, a change in the resistivity (resistance or impedance) with respect to the temperature change of the separators 28 is shown in a diagram.

As shown in FIG. 3A, for example, a current collector (electrode) 44 in which a negative electrode active material is coated on each of the negative electrode active materials to form a negative electrode layer 42 is used to measure the shutdown temperature Tsd. The negative electrode layers 42 are opposed to each other with the separators 28 to be measured interposed therebetween, and are pressed and brought into close contact with each other by 1 MPa. At this time, the negative electrode layer 42 and the separator 28 are enclosed in the laminate sheet 46.

In this condition, a 1 kHz is applied between the pair of current collectors 44, and the resistivity (Ω) between the pair of current collectors 44 is measured while the temperature is increased (for example, from 20° C. or 25° C.).

As a result, as shown in FIG. 3B, the resistive value between the pair of current collectors 44 initially maintains a high value (e.g., a value of about four orders of magnitude), but decreases rapidly as the temperature T increases to some extent. Thus, for example, the temperature T when the resistivity is decreased by two orders of magnitude or more is set (defined) as the shutdown temperature Tsd of the separator 28 to be measured.

In the bipolar battery 10, when the temperature T reaches the shutdown temperature Tsd of the separator 28 (T≥Tsd), the ion-permeability of the separator 28 is not stopped, and charging and discharging of the bipolar electrode 12 are stopped. Accordingly, the melting point Tm of the heterogeneous portion 40 can be set to a temperature (Tsd≤Tm<Tms) that is equal to or higher than the shutdown temperature Tsd of the separators 28 and lower than the melting point Tms of the other portions of the frame body 32.

Further, it is more preferable that the melting point Tm of the heterogeneous portion 40 is set to a temperature higher than the shutdown temperature Tsd of the separator 28 and a temperature (Tsd<Tm<Tms) lower than the melting point Tms of the other portion of the frame body 32. Thus, in the bipolar battery 10, if the increase in the temperature T is suppressed, the heterogeneous portion 40 of the sealing portion 14 is not damaged, so that unnecessary damage to the sealing portion 14 can be suppressed.

In addition, when the temperature of the bipolar battery 10 further increases even when the temperature exceeds the shutdown temperature Tsd, the heterogeneous portion 40 of the sealing portion 14 becomes damageable. Accordingly, in the bipolar battery 10, it is possible to effectively suppress an increase in the temperature T. Moreover, in the bipolar battery 10, even when the sealing portion 14 is damaged, the damaged portion can be predicted, so that the safety against damage can be easily secured.

### Example 1

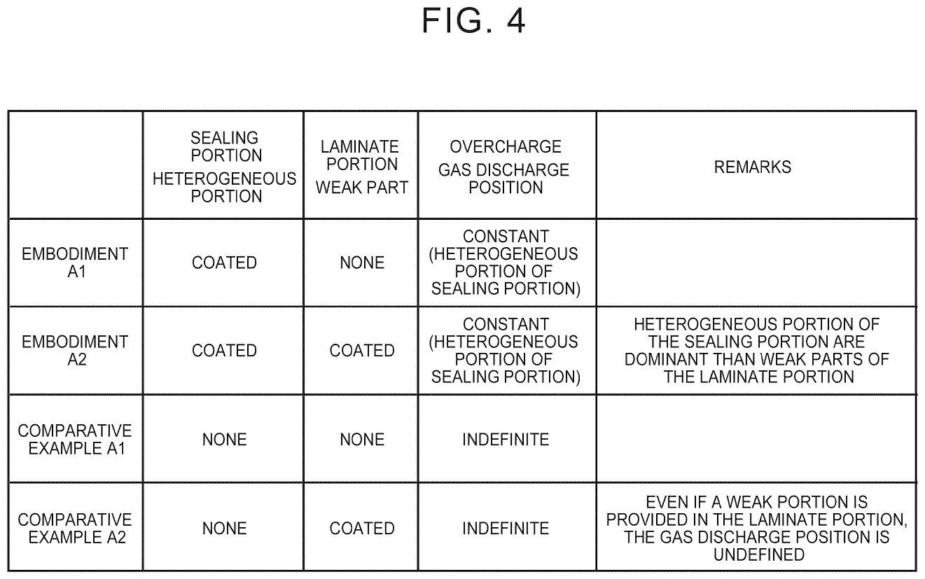

Here, a first embodiment of the present disclosure will be described. In the first embodiment, for each of the example A1, the example A2, the comparative example A1, and the comparative example A2, an overcharge test was performed to observe a change in the condition of the sealing portion (corresponding to the sealing portion 14) and the laminate portion (corresponding to the laminate portion 16), and the observations are shown in FIG. 4.

In the first example, the following configurations were applied to the example A1, example A2, comparative example A1, and comparative example A2.

As the bipolar electrode (corresponding to the bipolar electrode 12), NCM (nickel-cobalt-lithium manganate) is used as the positive electrode active material of the positive electrode layer, and is used as the negative electrode active material C (natural graphite) of the negative electrode layer.

To the electrolyte solution, a LiPF6 of 1.0 M is added to a solution (solvent) obtained by mixing EC (ethylene carbonate), EMC (ethyl methyl carbonate) and DMC (diethyl carbonate) in a volume ratio at a EC:EMC:DMC of 1:1:1.

In the sealing portion, PE (polyethylene) is used for the heterogeneous portion (corresponding to the heterogeneous portion 40). In the sealing portion, PET (polyethylene terephthalate) is used in a part other than the heterogeneous portion. In the sealing portion, the melting point Tm of the heterogeneous portion was made lower than the melting point Tms of the other portions (Tm<Tms).

The separator (corresponding to the separator 28) is made of PP (polypropylene) or PE, PP and has a three-layer PP/PE/PP structure. The separator has a shutdown temperature Tsd of 130° C.

The overcharge test started charging at a C rate of 1 C from 25° C. and continued charging until the gases generated inside were discharged to the outside (outside of the laminate portion).

The overcharge test is performed three times for each of the example A1, example A2, comparative example A1, and comparative example A2, and the emission direction of the gases is recorded. Of the four sides of the sealing portion (frame body), “constant” was evaluated when the gas was constantly discharged in one direction, and “indeterminate” was evaluated when the discharge direction was not determined in one direction.

The case where the heterogeneous portion is provided for the sealing portion is applied with “present”, the case where the heterogeneous portion is not provided with “none”, the examples A1, A2 are “present”, and the comparative examples A1, A2 are “none”.

In the test, a structure is added in which a “weak portion” is provided in which the laminate portion is more fragile than the other portions with respect to the internal pressure. The “weak portion” is formed by arranging a sheet tab having irregularities on the surface thereof so as to protrude from the inside to the outside at the joining portion of the two laminate sheets. In the example A2 and comparative example A2, the weak portion is provided to be “present”, and in the example A1 and comparative example A1, the “weak portion” is not provided to be “absent”.

As shown in FIG. 4, in the comparative example A1 and the comparative example A2 in which the heterogeneous portion is not provided, the assessment is “undefined”. In particular, in the comparative example A2, even if a “weak portion” is provided in the laminate portion, it is evaluated as “indefinite”, and it is clear that the “weak portion” of the laminate portion does not contribute to the emission direction of the gases.

On the other hand, in A1, A2 of the embodiment in which the heterogeneous portion is formed in the sealing portion, the assessment is “constant”. At this time, it becomes clear that the heterogeneous portion of the sealing portion is more dominant in the gas discharge direction than the “weak portion” of the laminate portion. Therefore, the exhaust direction of the gas can be appropriately controlled by providing the heterogeneous portion in the sealing portion.

### Second Embodiment

Next, a second embodiment will be described.

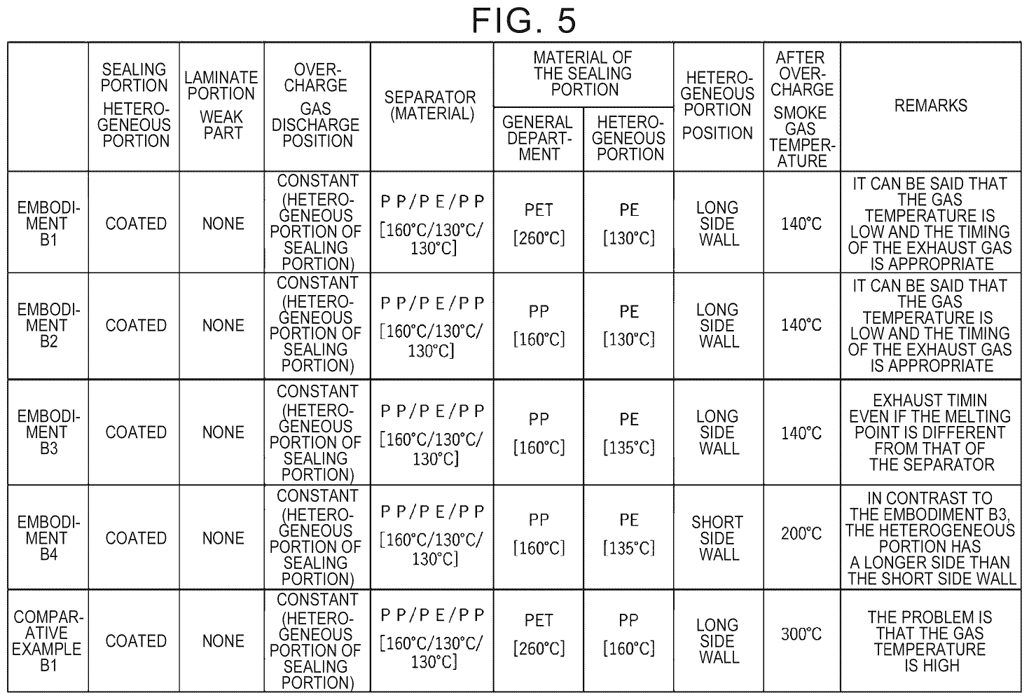

The basic configuration of the second embodiment is the same as that of the first embodiment. In the second embodiment, the change in condition of the sealing portion and the laminate portion is observed by performing an overcharge test for each of the example B1, example B2, example B3, example B4 and comparative example B1, and the observation result is shown in FIG. 5.

In the second embodiment, in addition to the configuration of the first embodiment, the configuration of the separator, the configuration of the sealing portion, the configuration and the position of the heterogeneous portion in the sealing portion were added to the bipolar electrode.

The separators had melting points of 160° C., 130° C. and 130° C. (shutdown Tsd of 130° C.) for PP/PE/PP, respectively. A PET with a melting point of 260° C. or a PP with a melting point of 160° C. was used at the site except for the heterogeneous portion of the sealing portion.

Further, the heterogeneous portion, PE melting point Tm is 130° C. or 135° C., or using a PP melting point is 160°, the position of the heterogeneous portion long side wall (corresponding to the long side wall 34) or short side wall (corresponding to the short side wall 36) was set. Note that B1 embodiment has the same configuration as that of A1 embodiment.

Furthermore, in the second example, an overcharge test was performed under the same conditions as in the first example. The household electric appliance charge test was performed three times for each of the example B1, example B2, example B3, example B4, and comparative example B1, and the temperature of the gas to be discharged was measured and recorded in addition to the gas discharge direction.

As shown in FIG. 5, in B1, B2, B3 of the embodiment, the material of the sealing portion (the portion other than the heterogeneous portion) or the melting point Tm of the heterogeneous portion is different, but the gas discharge direction is evaluated to be constant, and the temperature of the gas to be discharged is also the same. In addition, the temperature of the gas is also lower than that of the example B4 and the comparative example B1. From this, in B1 to B3 of the embodiment, it is possible to evaluate that the timing at which the gases are discharged is appropriate.

Further, as shown in B3 of the embodiment, even if the melting point Tm of the heterogeneous portion with respect to the melting point of the separator (shutdown temperature Tsd) is high, if the difference is small (e.g., about 5° C.), the melting point Tm of the heterogeneous portion with respect to the melting point of the separator is the same temperature substantially the same can be evaluated.

Further, in B4 embodiment, the heterogeneous portion is provided on the short side wall. Therefore, in B4 embodiment, the temperature of the exhausted gases is higher than in B3 embodiment in which the heterogeneous portion is provided on the long side wall.

Further, in the comparative example B1, the melting point Tm of the heterogeneous portion is the same as the melting point (shutdown temperature Tsd) of PP of the separator. The high melting point of the heterogeneous portion, the temperature of the gas is extremely high despite providing the heterogeneous portion on the long side wall.

Therefore, it is sufficient that the melting point of the heterogeneous portion is lower than the melting point of the other portion of the sealing portion and is equal to or higher than the shutdown temperature of the separator. In addition, the heterogeneous portion may have a melting point lower than the melting point of the other portion of the sealing portion and a melting point higher than the shutdown temperature of the separator. Further, the heterogeneous portion may be provided on the short side wall in the stacking direction view of the bipolar electrode in the sealing portion, it is more preferable to be provided on the long side wall.

What is claimed is:

1. A bipolar battery comprising:
a bipolar electrode in which a positive electrode layer and a negative electrode layer are disposed between a pair of current collectors, and a separator as an electrolyte layer having a predetermined shutdown temperature is disposed between the positive electrode layer and the negative electrode layer;
a sealing portion in which each bipolar electrode is sealed by holding a peripheral edge portion of each of the current collectors when the bipolar electrode is stacked and accommodated inside the sealing portion; and
a heterogeneous portion provided in the sealing portion along a stacking direction of the bipolar electrode, the heterogeneous portion having a melting point that is lower than a melting point of other portions of the sealing portion and equal to or higher than the shutdown temperature of the separator.

2. The bipolar battery according to claim 1, wherein:
the sealing portion includes a plurality of frame bodies, the frame bodies being stacked with the bipolar electrode accommodated inside each of the frame bodies to allow the bipolar electrode to be stacked, and the frame bodies holding the peripheral edge portion of each of the current collectors of the bipolar electrode; and
the heterogeneous portion is provided on each of the frame bodies and provided in the stacking direction in the sealing portion.

3. The bipolar battery according to claim 1, wherein:
the sealing portion is formed in a rectangular shape by a short side wall and a long side wall that is longer than the short side wall when seen in the stacking direction of the bipolar electrode; and
the heterogeneous portion is provided at an intermediate portion along a direction intersecting the stacking direction of the long side wall.

4. The bipolar battery according to claim 1, wherein the heterogeneous portion has the melting point that is higher than the shutdown temperature of the separator.
